(19) United States
(12) Patent Application Publication
(10) Pub. No.: US 2007/0147927 A1
(43) Pub. Date: Jun. 28, 2007

(54) Image forming apparatus, image forming method, and computer readable recording medium storing control program

(75) Inventors: Hiroshi Nogawa, Tokyo (JP); Yoko Fujiwara, Tokyo (JP); Masahiro Ozawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/400,303

(22) Filed: Apr. 10, 2006

(30) Foreign Application Priority Data
Dec. 27, 2005 (JP) PAT. 2005-375408

(51) Int. Cl. B41J 5/30

(52) U.S. Cl. 400/62

(57) ABSTRACT

Disclosed is an image forming device including an inputting unit to input print data from an external device; a printing unit to execute printing according to the print data; and a control unit to control the image forming device, wherein the control unit determines whether a printing size included in the print data is within a printable size area of the image forming device; determines whether the printing size is within a size area larger than the printable size area in case it is determined that the printing size is not within the printable size area; and executes printing according to the print data to the printing unit in case it is determined that the printing size is within the size area larger than the printable size area.

### BACKGROUND OF THE INVENTION

1. Field of the Invention

The present invention relates to an image forming apparatus, an image forming method, and a computer readable recording medium storing control program, that conducts printing according to a print data inputted from an external device.

2. Description of the Related Art

In a case where printing is conducted by sending print data from a computer such as PC (Personal Computer) to an image forming device (printing device), when a printing size is assigned to custom size, an error occurs to a printing size assigned by the OS (Operating System) of the computer, therefore a printing size included in the print data may not be within the area supported by the image forming device (hereinafter referred to as “printable size area”). In such case, concerning a conventional image forming device, printing was performed on a paper sheet which is set by default in the image forming device, or processing such as changing the size or direction of the image subject to printing, were performed. For example, in Japanese Laid-open Patent Specification No. 2000-115515 and Japanese Laid-open Patent Specification No. 2001-86326, techniques to conduct printing without waste of paper sheet are disclosed. According to the technique, in case where a manuscript of custom size has a size different from the size of paper sheet of the image forming device, both sizes are compared, and image of the manuscript is expanded, reduced, rotated, or the like, according to the comparison result.

Hereinafter, an example of image forming processing executed by a conventional image forming device will be described, with reference to flow chart of FIG. 1.

When a print data is inputted from a computer connected to an image forming device, printing size included in the print data and a printable size area supported by the image forming device are compared (step T1), and it is determined whether the printing size is within the printable size area (step T2).

In step T2, when it is determined that the printing size included in the print data is within the printable size area (step T2; YES), print processing according to the print data is performed (step T6), and the image forming processing is concluded.

In step T2, when it is determined that the printing size included in the print data is not within the printable size area (step T2; NO), an area of the printing size is rotated by 90 degrees (or by 270 degrees) to the printable size area, and then the printing size after rotation and the printable size area are compared (step T3). Subsequently, it is determined whether printing size after rotation by 90 degrees is within the printable size area (step T4).

In step T4, when it is determined that the printing size after rotation by 90 degrees (or by 270 degrees) is within the printable size area (step T4; YES), print processing according to the print data is performed (step T6), and the image forming processing is concluded.

In step T4, when it is determined that the printing size after rotation by 90 degrees (or by 270 degrees) is not within the printable size area (step T4; NO), a processing for cases where the printing size is not within the printable size area is performed (step T5), and the image forming processing is concluded. As for an example of processing for cases where the printing size is not within the printable size area in step T5, print processing on a paper sheet which is set by default in the image forming device can be mentioned.

However, in the conventional image forming device, in a case where the printing size of custom size included in the print data is determined that it is not within the printable size area due to the aforementioned error that occurs by the types of OS, printing is performed on a paper sheet which is set by default in the image forming device, even in case where there is a paper sheet of custom size set in the image forming device. Therefore, a problem arises in that appropriate image forming corresponding to the printing size cannot be performed.

### SUMMARY

The present invention has been made to solve the above problem. An object of the invention is to enable appropriate image forming even in case where the printing size included in the print data is not within the printable size area set in the image forming device.

An image forming device according to an embodiment reflecting an aspect of the invention comprises: an inputting unit to input print data from an external device; a printing unit to execute printing according to the print data; and a control unit to control the image forming device; wherein the control unit determines whether a printing size included in the print data is within a printable size area of the image forming device; determines whether the printing size is within a size area larger than the printable size area in case it is determined that the printing size is not within the printable size area; and makes the printing unit execute printing according to the print data in case it is determined that the printing size is within the size area larger than the printable size area.

Additionally, the control unit may rotate an area of the printing size to the printable size area in case it is determined that the printing size is not within the printable size area, and determines whether a printing size after rotation is within the printable size area.

Further, the control unit may rotate an area of the printing size to the size area larger than the printable size area in case it is determined that the printing size is not within the size area larger than the printable size area, and determines whether a printing size after rotation is within the size area larger than the printable size area.

Preferably, the printing size included in the print data is out of range of a standardized size.

An image forming method according to an embodiment reflecting an aspect of the invention comprises: a print data inputting step to input print data from an external device; a first determining step to determine whether a printing size included in the print data is within a printable size area of an image forming device; a second determining step to determine whether the printing size is within a size area larger than the printable size area in case it is determined that the printing size is not within the printable size area; and a printing executing step to execute printing according to the print data by the image forming device in case it is determined that the printing size is within the size area larger than the printable size area.

Additionally, the image forming method may further comprise a third determining step to determine whether a printing size after rotation is within the printable size area, wherein the rotation is to rotate an area of the printing size to the printable size area in case it is determined that the printing size is not within the printable size area.

Further, the image forming method may further comprise a fourth determining step to determine whether a printing size after rotation is within the size area larger than the printable size area, wherein the rotation is to rotate an area of the printing size to the size area larger than the printable size area in case it is determined that the printing size is not within the size area larger than the printable size area.

Preferably, the printing size included in the print data is out of range of a standardized size.

A computer readable recording medium according to an embodiment reflecting an aspect of the invention, which stores a control program which is executed by a control unit of an image forming device that executes printing according to a print data inputted from an external device, the control program that causes the control unit to execute a process comprising: a first determining step to determine whether a printing size included in the print data is within a printable size area of the image forming device; a second determining step to determine whether the printing size is within a size area larger than the printable size area in case it is determined that the printing size is not within the printable size area; and a printing executing step to execute printing according to the print data to a printing unit in case it is determined that the printing size is within the size area larger than the printable size area.

Additionally, the control program may further cause the control unit execute: a third determining step to determine whether a printing size after rotation is within the printable size area, wherein the rotation is to rotate an area of the printing size to the printable size area in case it is determined that the printing size is not within the printable size area.

Further, the control program of may further cause the control unit execute: a fourth determining step to determine whether a printing size after rotation is within the size area larger than the printable size area, wherein the rotation is to rotate an area of the printing size to the size area larger than the printable size area in case it is determined that the printing size is not within the size area larger than the printable size area.

Preferably, the printing size included in the print data is out of range of a standardized size.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a flowchart showing an image forming processing executed by a conventional image forming device;

FIG. 2 is a view showing a structure of an image forming system according to the embodiment of the present invention;

FIG. 3 is a block diagram showing a structure of main portion of a computer according to the embodiment;

FIG. 4 is a block diagram showing a structure of main portion of an image forming device according to the embodiment;

FIG. 5 is a view showing a printable size area of the image forming device;

FIG. 6 is a view showing the printable size area and a size area of the printable size area which is expanded;

FIGS. 7A and 7B are views showing relation between the printable size area and a printing size which is set;

FIGS. 8A through 8D are views showing relation between the printing size which is set and the printable size area, according to the first embodiment;

FIGS. 9A and 9B are views showing relation between the printable size area and the printing size which is set;

FIGS. 10A through 10D are views showing a relation between the printing size which is set and the printable size area, according to the second embodiment; and

FIG. 11 is a flowchart showing an image forming processing executed by the image forming device according to the embodiment.

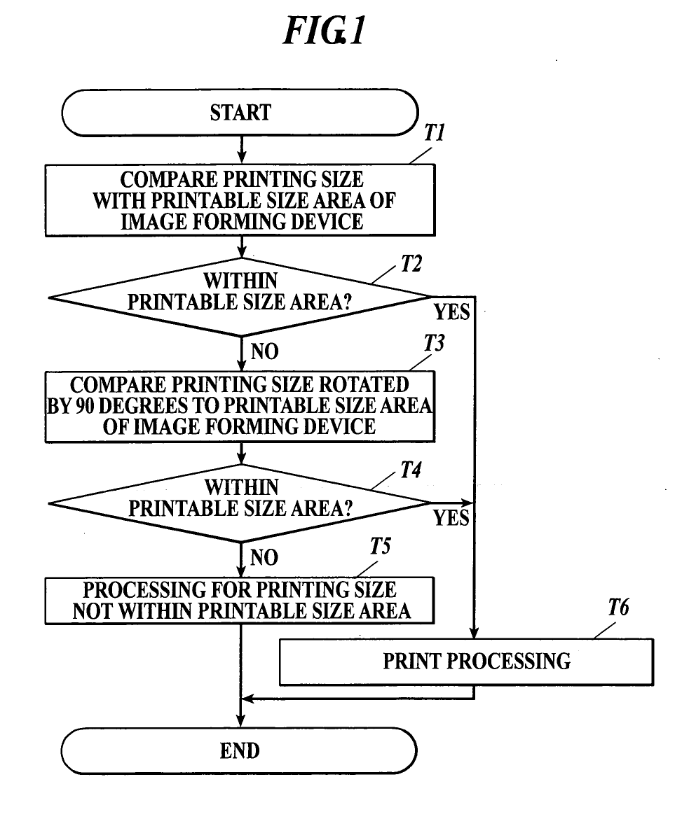

### DETAILED DESCRIPTION OF THE PREFERRED EMBODIMENTS

An embodiment of the present invention will be described below with reference to figures.

First of all, a system structure according to the embodiment will be explained.

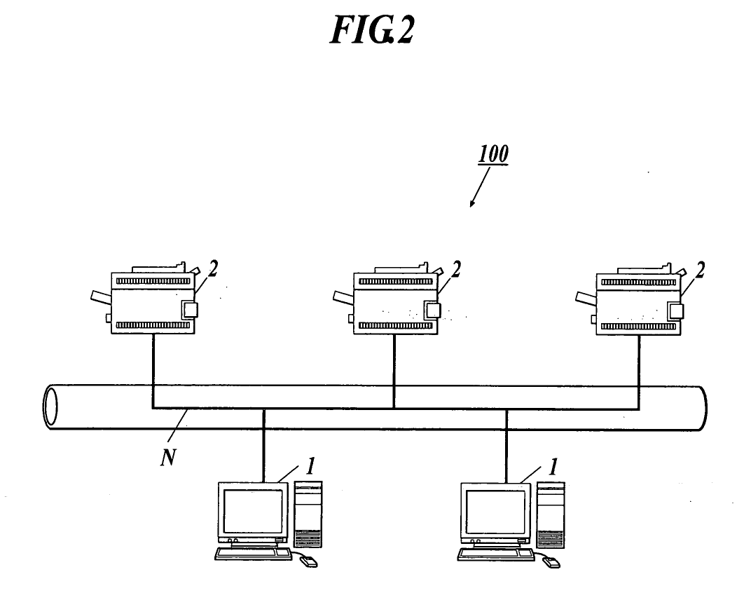

FIG. 2 shows a structure of an image forming system 100 according to the embodiment of the present invention. As shown in FIG. 2, the image forming system 100 comprises a computer 1 such as PC (Personal Computer) and an image forming device 2. The computer 1 and the image forming device 2 are connected through a communication network N.

The communication network N comprises LAN (Local Area Network) which connects apparatuses through standards such as Ethernet (registered trademark), TokenRing, FDDI (Fiber Distributed Data Interface), and the like; WAN (Wide Area Network) which connects the LAN through an exclusive line; and the like.

Here, the number of computer 1 and the number of image forming device 2 connected to the communication network N is not limited. In addition, connecting means for the computer 1 and the image forming device 2 is not limited to network connection, and may be connected through a local connection.

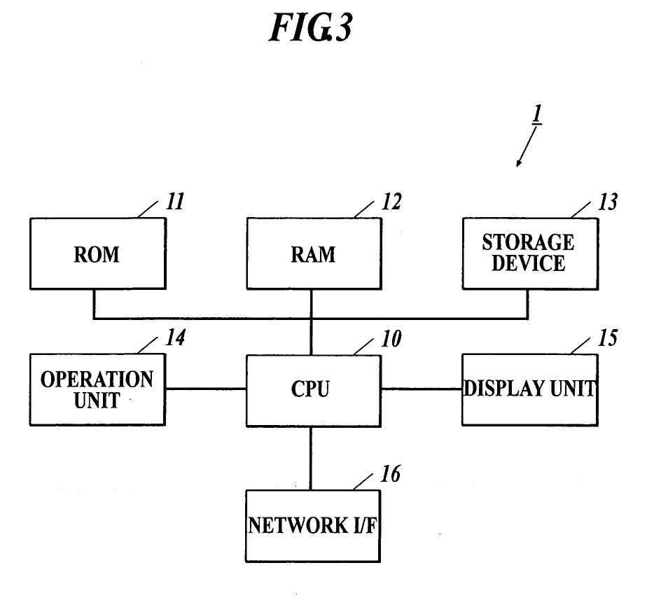

FIG. 3 shows a structure of main portion of the computer 1. As shown in FIG. 3, the computer 1 comprises CPU (Central Processing Unit) 10, ROM (Read Only Memory) 11, RAM (Random Access Memory) 12, storage device 13, operation unit 14, display unit 15, and network I/F 16.

The CPU 10 controls performance of each unit of the computer 1 according to a control program stored in the ROM 11. For example, when printing of a file is instructed from an operation unit 14, the CPU 10, by using a printer driver which is a software to control printing, executes processing which converts the file into page description languages (PDL) such as PS (PostScript), PCL (Printer Control Language), and the like, and sends them to the image forming device 2 through the network I/F 16.

The ROM 11 stores control program to actualize various kinds of functions of the computer 1 executed by the CPU 10, and data used when the control program is executed.

The RAM 12 spreads various kinds of control programs executed by CPU 10 in the program storage area, and temporarily stores data, such as processing result obtained by executing these control programs, in a work area.

The storage device 13 comprises a recording medium that conducts record reproduction magnetically or optically, a recording medium of a semiconductor memory, and the like, and conducts writing and reading of instructed data. This recording medium is either provided fixedly, or attached in a detachable manner to the storage device 13.

The operation unit 14 includes numeric keypad, cursor key, and various kinds of functional keys, and outputs an operation signal of key depression to the CPU 10.

The display unit 15 comprises a display such as LCD (Liquid Crystal Display) and the like, and performs required display processing corresponding to a display control signal inputted from the CPU 10.

The network I/F 16 is an interface to connect the computer 1 with external device through communication network N. As for the external device, the image forming device 2 and the like can be mentioned.

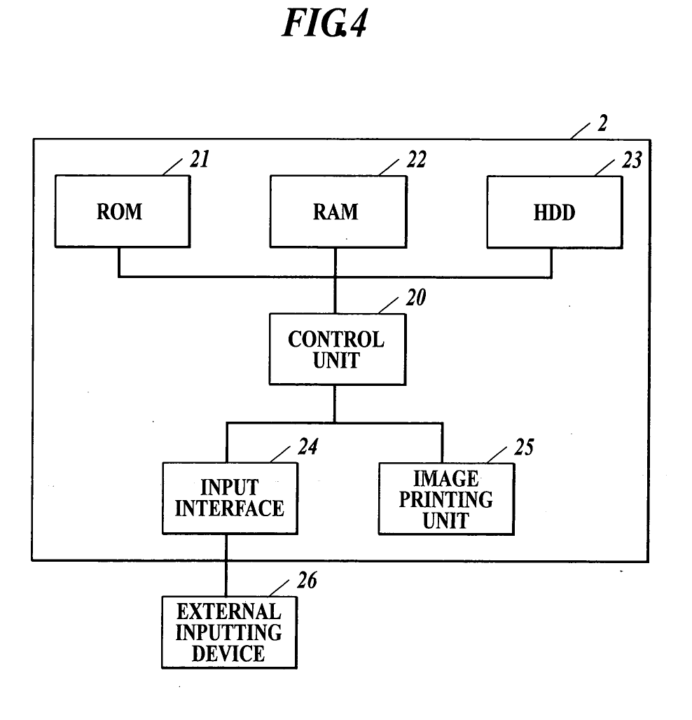

FIG. 4 shows a structure of main portion of the image forming device 2. The image forming device 2 is a printing device which conducts printing according to an inputted print data. As shown in FIG. 4, the image forming device 2 comprises control unit 20, ROM 21, RAM 22, HDD (Hard Disk Drive) 23, input interface 24, and image printing unit 25.

The control unit 20 includes CPU, and controls performance of each unit of the image forming device 2 corresponding to a control program stored in the ROM 21.

For example, the control unit 20 controls image forming processing according to print data inputted from external inputting device 26 (computer 1) through the input interface 24. Specifically, in case where a printing size included in the print data which was inputted is not within a printable size area supported by the image forming device 2, it is determined whether the printing size is within a size area larger than the printable size area. When it is determined that the printing size is within the size area larger than the printable size area, printing according to the print data is executed by the image printing unit 25. Here, as for printing size that is within the printable size area, other than sizes that satisfy the standards (so-called standard size) such as A4, B5, letter size, and the like, various kinds of sizes other-than the standard side (so-called custom size) can be included as an example. Additionally, as for printing size that is not within the printable size area, paper whose size is within standard size or custom size, but exceeds the capacity of the printing device; (an A3 size paper, in case of a printing device which can handle up to A4 size, for example) and paper of small size (a paper with a shorter length than the distance between paper sheet feeding rollers, for example); can be included. Image forming processing executed under control by the control unit 20 will be described later in detail, with reference to FIG. 5 through FIG. 11.

The ROM 21 stores control program to actualize performances concerning various kinds of functions of the image forming device 2, executed by the control unit 20, and data (font data, for example) used in case of executing the control program.

The RAM 22 spreads various kinds of control programs executed by CPU of the control unit 20 in the program storage area, and temporarily stores data, such as inputted print data, processing result obtained by executing the various kinds of control programs, and the like in a work area. HDD 23 stores job data, data of additional font, and the like.

The input interface 24 is an interface to connect with the external inputting device 26. As for the external inputting device 26, computer 1 connected through communication network N and computer 1 connected through local connection can be mentioned as an example.

The image printing unit 25 executes printing according to print data inputted from the external inputting device 26 (computer 1), by the predetermined printing method (electrographic method and ink jet method for example), in correspondence with printing control signal sent from the control unit 20.

Next, image forming method of the image forming device 2 is described.

FIG. 5 shows an example of printable size area 30. In FIG. 5, a region which is surrounded by an outer and an inner solid lines is the printable size area 30. When the printing size included in the print data is not within the printable size area 30, conventionally, as a processing in case of printing size being out of range of printable size area, printing was performed on a paper sheet which is set by default in the image forming device. These processing is not desirable to a user who specified printing by a custom size.

The present embodiment, when the printing size included in the print data is not within the printable size area, instead of performing printing on a paper sheet which is set by default in the image forming device instantly, recognizes that it is within the printable size area by buffering the error of the printing size to the utmost extent, and forms an image.

Hereinafter, as a specific example of image forming method of the image forming device 2, Embodiment 1 and Embodiment 2 will be described.

### Embodiment 1

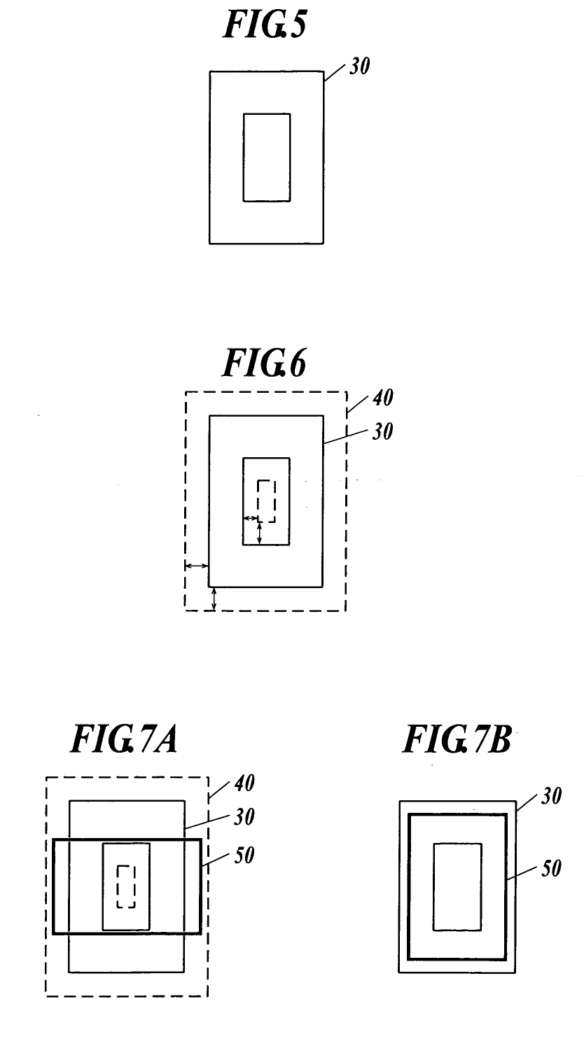

As Embodiment 1 of the present embodiment, a processing in case that the printing size included in the print data is larger than the printable size area 30 is described with reference to FIG. 6 through FIG. 8D.

As a manner to buffer the error in the printing size, the printable size area 30 supported by the image forming device is expanded virtually. FIG. 6 shows an example of a size area 40 (region surrounded by dotted line in FIG. 6) larger than the printable size area 30. Hereinafter, size area larger than the printable size area is referred to as “larger size area”.

The printing size included in the print data and the larger size area 40 is compared. In case that printing size is within the larger size area 40, the printing size is recognized to be within the printable size area supported by the image forming device 2, the image is clipped to fit in the printable size area, expanded, reduced, or rotated, and the image is formed.

However, when the printing size included in the print data is compared with the larger size area 40 in the first place, it is possible that, even though the printing size can fit in the original printable size area 30, determination that the printing size is within the larger size area 40 will be made, and therefore inappropriate image forming may be conducted. For example, as shown in FIG. 7A and FIG. 7B, printing size 50 should be performed with image forming by the printable size area 30 (FIG. 7B), however, image forming is performed by the larger size area 40 (FIG. 7A). This results in an image whose portion out of the range of printable size area is clipped, or the printing size is reduced.

In order to avoid such situation, in case of performing image forming, printing size included in the print data and the printable size area is compared. Subsequently, when the printing size is not within the printable size area, it is compared with the larger size area.

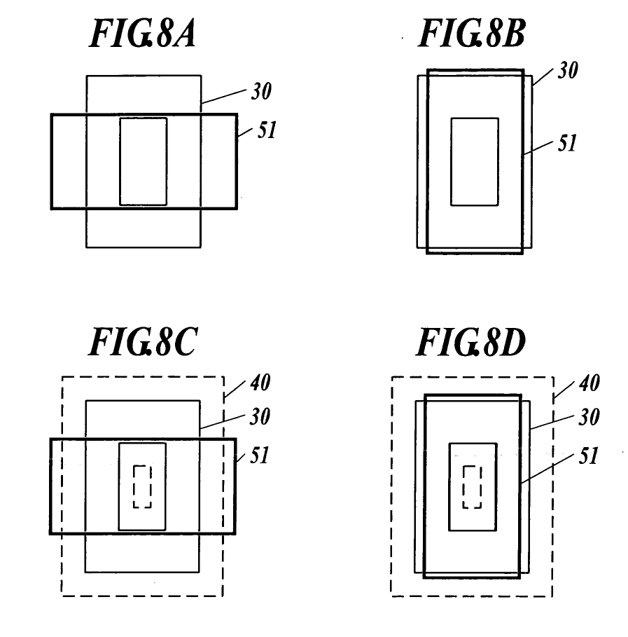

FIG. 8A through FIG. 8D show an example of image forming method in Example 1. First of all, printing size 51 included in the print data and the printable size area 30 is compared (FIG. 8A). As shown in FIG. 8A, in case that the printing size 51 is not within the printable size area 30, an area of the printing size 51 is rotated by 90 degrees to the printable size area 30, and the printing size 51 after rotation is compared with the printable size area 30 (FIG. 8B). As shown in FIG. 8B, in case that the printing size 51 after rotation by 90 degrees is not within the printable size area 30, printing size 51 before rotation is compared with the larger size area 40 (FIG. 8C). As shown in FIG. 8C, in case that the printing size 51 is not within the larger size area 40, an area of the printing size 51 is rotated by 90 degrees to the larger size area 40, and the printing size 51 after rotation is compared with the larger size area 40 (FIG. 8D). As shown in FIG. 8D, in case that the printing size 51 after rotation is within the larger size area 40, print processing is performed, regarding that printing size 51 fits in the printable size area of the image forming device 2.

When the printing size included in the print data does not fit in the printable size area even after conducting the steps described in order of FIG. 8A through FIG. 8D, it is determined that printing size is out of range of the printable size area, and processing for cases where the printing size is not within the printable size area is conducted. As a processing for cases where the printing size is not within the printable size area, printing is conducted on a paper sheet which is set by default in the image forming device, or a message promoting to supply paper sheet that corresponds to the specified printing size is displayed on an operation panel (not shown) of the image forming device or display of computer 1 (not shown) which sent the print data.

### Embodiment 2

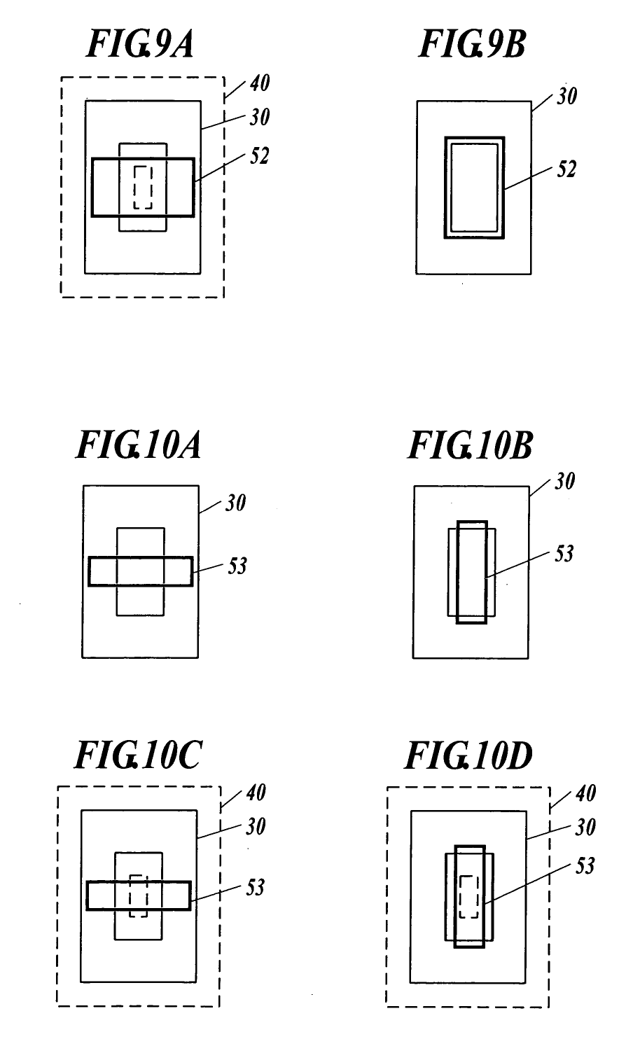

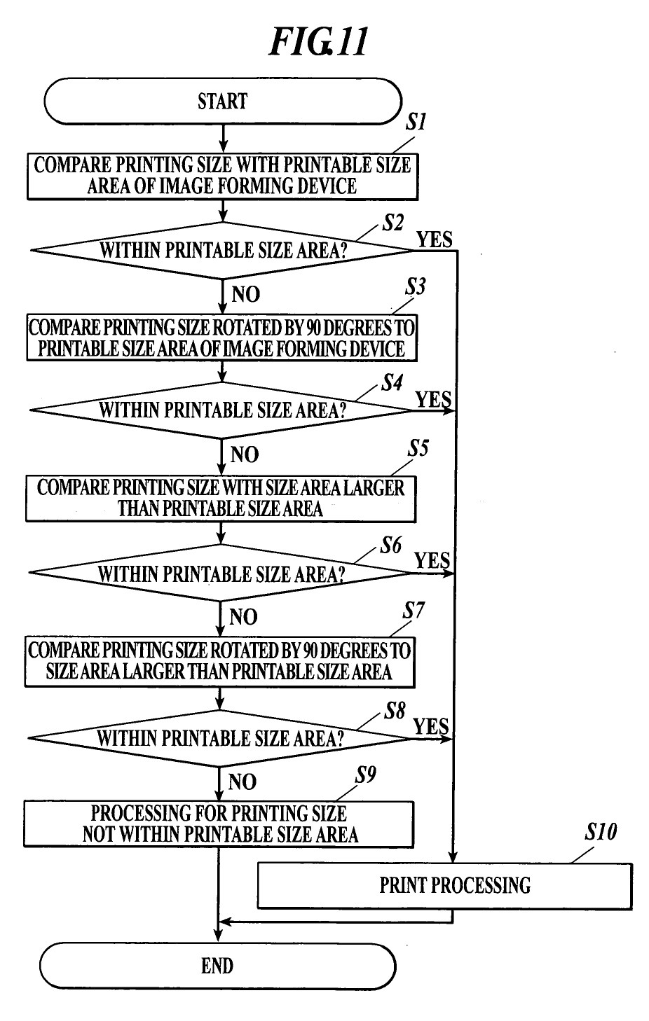

As Embodiment 2 of the present embodiment, a processing in case that the printing size included in the print data is smaller than the printable size area 30 is described with reference to FIG. 9A through FIG. 10D.

In Embodiment 2 as well, when the printing size included in the print data is compared with the larger size area 40 in the first place, it is possible that, even though the printing size can fit in the original printable size area 30, determination that the printing size is within the larger size area 40 will be made, and therefore inappropriate image forming may be conducted. For example, as shown in FIG. 9A and FIG. 9B, printing size 52 should be conducted with image forming by the printable size area 30 (FIG. 9B), however, image forming is conducted by the larger size area 40 (FIG. 9A). This results in an image whose portion out of the range of printable size area is clipped, or the printing size is reduced.

In order to avoid such situation, processing should be conducted in the order of FIG. 10A through FIG. 10D, as described hereinafter.

First of all, printing size 53 included in the print data and the printable size area 30 is compared (FIG. 10A). As shown in FIG. 10A, in case that the printing size 53 is not within the printable size area 30, an area of the printing size 53 is rotated by 90 degrees to the printable size area 30, and the printing size 53 after rotation is compared with the printable size area 30 (FIG. 10B). As shown in FIG. 10B, in case that the printing size 53 after rotation by 90 degrees is not within the printable size area 30, printing size 53 before rotation is compared with the larger size area 40 (FIG. 10C). As shown in FIG. 10C, in case that the printing size 53 is not within the larger size area 40, the area of the printing size 53 is rotated by 90 degrees to the larger size area 40, and the printing size 53 after rotation is compared with the larger size area 40 (FIG. 10D). As shown in FIG. 10D, in case that the printing size 53 after rotation is within the larger size area 40, print processing is performed, regarding that printing size 53 fits in the printable size area of the image forming device 2.

When the printing size included in the print data does not fit in the printable size area even after performing the steps described in order of FIG. 10A through FIG. 10D, it is determined that printing size is out of range of the printable size area, and as in Example 1, processing for cases where the printing size is not within the printable size area is conducted.

Next, performance of the present embodiment is described.

As a performance of the present embodiment, image forming processing executed under control of control unit 20 of the image forming device 2 is described in detail, with reference to flowchart of FIG. 11.

When print data is inputted from the computer 1, first of all, printing size included in the print data is compared with printable size area of the image forming device 2 (step S1), and it is determined whether-the printing size is within the printable size area or not (step S2). In step S2, when it is determined that the printing size included in the print data is within the printable size area (step S2; Yes), print processing according to the print data is conducted at image printing unit 25 (step S10), and the image forming processing is completed.

In step S2, when it is determined that the printing size included in the print data is not within the printable size area (step S2; No), an area of the printing size is rotated by 90 degrees to the printable size area, and the printing size after rotation is compared with the printable size area of the image forming device 2 (step S3). Subsequently, it is determined whether the printing size after rotation by 90 degrees is within the printable size area or not (step S4).

In step S4, when it is determined that the printing size after rotation by 90 degrees is within the printable size area (step S4; Yes), print processing is conducted by the printing size after rotation by 90 degrees, at image printing unit 25 (step S10), and the image forming processing is completed.

In step S4, when it is determined that the printing size after rotation by 90 degrees is not within the printable size area (step S4; No), printing size included in the print data is compared with the size area larger than the printable size area (step S5). Subsequently, it is determined whether the printing size is within the size area larger than the printable size area or not (step S6).

In step S6, when it is determined that the printing size is within the size area larger than the printable size area (step S6; Yes), print processing according to the print data is conducted at image printing unit 25 (step S10), and the image forming processing is completed.

In step S6, when it is determined that the printing size is not within the size area larger than the printable size area (step S6; No), the area of printing size is rotated by 90 degrees to the size area larger than the printable size area, and the printing size after rotation is compared with the size area larger than the printable size area (step S7). Subsequently, it is determined whether the printing size after rotation by 90 degrees is within the size area larger than the printable size area or not (step S8).

In step S8, when it is determined that the printing size after rotation by 90 degrees is within the size area larger than the printable size area (step S8; Yes), print processing is conducted by the printing size after rotation by 90 degrees, at image printing unit 25 (step S10), and the image forming processing is completed.

In step S8, when it is determined that the printing size after rotation by 90 degrees is not within the size area larger than the printable size area (step S8; No), processing for cases where the printing size is not within the printable size area is conducted (step S9), and the image forming processing is concluded. As a processing of step S9 for cases where the printing size is not within the printable size area, printing is conducted on a paper sheet which is set by default in the image forming device 2. Alternatively, a processing to display a message promoting to supply paper sheet that corresponds to the specified printing size on an operation panel (not shown) of the image forming device 2, and a processing to send to the computer 1 that sent the print data, a data which commands the computer 1 to display the message, may be conducted.

Here, in steps S3 and S7, the rotation angle of the printing size area is 90 degrees, however, the angle can also be 270 degrees.

As described, according to the image forming device 2 of the present embodiment, even in the case that the printing size included in the print data sent from computer 1 is not accurately within the printable size area supported by the image forming device 2, due to an error caused by the type of OS, since the error in the printing size can be buffered to a maximum extent by expanding the printable size area, it is possible to reduce the printing size from being out of range of printable size area. Therefore, appropriate image forming can be achieved.

Additionally, in a case that the printing size included in the print data is not within the printable size area, by rotating the area of the printing size and comparing once again with the printable size area, appropriate image forming can be further enhanced.

The present U.S. patent application claims a priority under the Paris Convention of Japanese patent application No. 2005-375408 filed on Dec. 27, 2005, and shall be a basis of correction of an incorrect translation.

What is claimed is:

1. An image forming apparatus comprising:
an inputting unit to input print data from an external device;
a printing unit to execute printing according to the print data; and
a control unit to control the image forming device; wherein
the control unit determines whether a printing size included in the print data is within a printable size area of the image forming device;
determines whether the printing size is within a size area larger than the printable size area in case it is determined that the printing size is not within the printable size area; and
makes the printing unit execute printing according to the print data in case it is determined that the printing size is within the size area larger than the printable size area.

2. The image forming device of claim 1, wherein the control unit rotates an area of the printing size to the printable size area in case it is determined that the printing size is not within the printable size area, and determines whether a printing size after rotation is within the printable size area.

3. The image forming device of claim 1, wherein the control unit rotates an area of the printing size to the size area larger than the printable size area in case it is determined that the printing size is not within the size area larger than the printable size area, and determines whether a printing size after rotation is within the size area larger than the printable size area.

4. The image forming device of claim 1, wherein the printing size included in the print data is out of range of a standardized size.

5. An image forming method comprising:
inputting print data from an external device;
determining whether a printing size included in the print data is within a printable size area of an image forming device;
determining whether the printing size is within a size area larger than the printable size area in case it is determined that the printing size is not within the printable size area; and
executing printing according to the print data by the image forming device in case it is determined that the printing size is within the size area larger than the printable size area.

6. The image forming method of claim 5, further comprising:
determining whether a printing size after rotation is within the printable size area, wherein the rotation is to rotate an area of the printing size to the printable size area in case it is determined that the printing size is not within the printable size area.

7. The image forming method of claim 5, further comprising:
determining whether a printing size after rotation is within the size area larger than the printable size area, wherein the rotation is to rotate an area of the printing size to the size area larger than the printable size area in case it is determined that the printing size is not within the size area larger than the printable size area.

8. The image forming method of claim 5, wherein the printing size included in the print data is out of range of a standardized size.

9. A computer readable recording medium which stores a control program which is executed by a control unit of an image forming device that executes printing according to a print data inputted from an external device, the control program that causes the control unit to execute a process comprising:
determining whether a printing size included in the print data is within a printable size area of the image forming device;
determining whether the printing size is within a size area larger than the printable size area in case it is determined that the printing size is not within the printable size area; and
executing printing according to the print data to a printing unit in case it is determined that the printing size is within the size area larger than the printable size area.

10. The computer readable recording medium which stores the control program of claim 9, further causing the control unit execute:
determining whether a printing size after rotation is within the printable size area, wherein the rotation is to rotate an area of the printing size to the printable size area in case it is determined that the printing size is not within the printable size area.

11. The computer readable recording medium which stores the control program of claim 9, further causing the control unit execute:
determining whether a printing size after rotation is within the size area larger than the printable size area, wherein the rotation is to rotate an area of the printing size to the size area larger than the printable size area in case it is determined that the printing size is not within the size area larger than the printable size area.

12. The computer readable recording medium which stores the control program of claim 9, wherein the printing size included in the print data is out of range of a standardized size.
